(19) United States
(12) Patent Application Publication
(10) Pub. No.: US 2025/0165836 A1
(43) Pub. Date: May 22, 2025

(54) SPARSE NOISE TOMOGRAPHY-BASED QUBIT MAPPING

(71) Applicant: International Business Machines Corporation, Armonk, NY (US)

(72) Inventors: Ritajit Majumdar, Kolkata (IN); Bibek Pokharel, San Jose, CA (US); Zlatko Kristev Minev, White Plains, NY (US); Mirko Amico, Pacific Palisades, CA (US)

(21) Appl. No.: 18/514,370

(22) Filed: Nov. 20, 2023

(51) Int. Cl. G06N 10/60

(52) U.S. Cl. CPC G06N 10/60

(57) ABSTRACT

One or more systems, devices, computer program products and/or computer-implemented methods of use provided herein relate to sparse noise tomography-based qubit mapping. The computer-implemented system can comprise a memory that can store computer executable components. The computer-implemented system can further comprise a processor that can execute the computer executable components stored in the memory, wherein the computer executable components can comprise a learning component that can employ sparse tomography to learn noise of a quantum computing device to build a sparse noise model of the quantum computing device, and a selection component that can select, based on the sparse noise model and a quantum circuit, nodes and edges of a graph topology of the quantum computing device by removing selected qubits. Furthermore, sets of embedding layouts of the quantum circuit on remaining graph fragments can be scored based on the sparse noise model to select an optimal virtual-to-physical qubit mapping.

### BACKGROUND

The subject disclosure relates to qubit mapping and, more specifically, to sparse noise tomography-based qubit mapping.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable sparse noise tomography-based qubit mapping.

According to an embodiment, a computer-implemented system is provided. The computer-implemented system can comprise a memory that can store computer executable components. The computer-implemented system can further comprise a processor that can execute the computer executable components stored in the memory, wherein the computer executable components can comprise a quantum computing device, a learning component that can employ sparse tomography to learn noise of the quantum computing device to build a sparse noise model of the quantum computing device, and a selection component that can retain, based on the sparse noise model and a quantum circuit, nodes and edges of a graph topology of the quantum computing device by removing selected qubits.

According to another embodiment, a computer-implemented method is provided. The computer-implemented method can comprise employing sparse tomography to learn noise of a quantum computing device to build a sparse noise model of the quantum computing device, and retaining, based on the sparse noise model and a quantum circuit, nodes and edges of a graph topology of the quantum computing device by removing selected qubits.

According to yet another embodiment, a computer program product for facilitating sparse noise tomography-based qubit mapping is provided. The computer program product can comprise a computer readable storage medium having program instructions embodied therewith, the program instructions executable by a processor to cause the processor to engage a learning component that employs sparse tomography to learn noise of a quantum computing device to build a sparse noise model of the quantum computing device, and engage a selection component that retains, based on the sparse noise model and a quantum circuit, nodes and edges of a graph topology of the quantum computing device by removing selected qubits.

### BRIEF DESCRIPTION OF THE DRAWINGS

One or more embodiments are described below in the Detailed Description section with reference to the following drawings:

FIG. 1 illustrates a block diagram of an example, non-limiting system 100 that can facilitate sparse noise tomography-based qubit mapping in accordance with one or more embodiments described herein.

FIG. 2 illustrates a block diagram of an example, non-limiting system 200 that can facilitate sparse noise tomography-based qubit mapping in accordance with one or more embodiments described herein.

FIG. 3 illustrates an example, non-limiting representation of qubit mapping a quantum circuit onto a quantum computing device in accordance with one or more embodiments described herein.

FIG. 4 illustrates an example, non-limiting representation sparse noise tomography-based qubit mapping in accordance with one or more embodiments described herein.

FIG. 5 illustrates an example, non-limiting representation of learning noise of a quantum computing device in accordance with one or more embodiments described herein.

FIG. 6 illustrates an example, non-limiting representation of balanced coloring for noise learning or a quantum computing device in accordance with one or more embodiments described herein.

FIG. 7 illustrates an example, non-limiting representation of qubit selection of a quantum computing device in accordance with one or more embodiments described herein.

FIG. 8 illustrates an example, non-limiting representation of scoring nodes and edges for qubit selection of a quantum computing device in accordance with one or more embodiments described herein.

FIG. 9 illustrates an example, non-limiting representation of qubit selection of a quantum computing device in accordance with one or more embodiments described herein.

FIG. 10 illustrates an example, non-limiting representation of scoring nodes and edges for qubit selection of a quantum computing device in accordance with one or more embodiments described herein.

FIG. 11 illustrates an example, non-limiting representation of obtaining, scoring, and selecting embedding layouts in accordance with one or more embodiments described herein.

FIG. 12 illustrates an example, non-limiting representation of relearning, rescoring, and selecting a set of embedding layouts in accordance with one or more embodiments described herein.

FIG. 13 illustrates an example, non-limiting plot of experimental results on a quantum circuit in accordance with one or more embodiments described herein.

FIG. 14 illustrates an example, non-limiting plot of experimental results on a quantum circuit in accordance with one or more embodiments described herein.

FIG. 15 illustrates a flow diagram of an example, non-limiting method for facilitating sparse noise tomography-based qubit mapping in accordance with one or more embodiments described herein.

FIG. 16 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Qubit mapping (e.g., qubit embedding) is a process in quantum computing that comprises assigning or mapping virtual qubits (e.g., logical qubits) in a quantum circuit onto physical qubits on a quantum computing device. A quantum circuit is a sequence of quantum gates applied to qubits to perform quantum computations. Optimized qubit mapping can enable improved algorithmic performance (e.g., faster computation, reduced noise effects, efficient use of available computational resources).

However, methods of qubit mapping face various challenges. Connectivity and topology of quantum hardware can impact the efficiency and performance of quantum algorithms. Quantum hardware has a limited number of qubits, and thus, achieving a fault-tolerant, error-corrected quantum computer with a sufficient number of high-quality qubits remains a significant challenge. Finding an optimal mapping of a logical qubit to a set of physical qubits that minimizes gate distances, reduces errors, and maximizes algorithmic performance is a complex problem. Efficient qubit placement algorithms are needed to improve gate fidelities and overall algorithm runtime.

Moreover, quantum systems are inherently noisy and error-prone. Errors in qubits, gates, and measurements can significantly affect outcomes of quantum algorithms. Noise can affect performance and outcomes of quantum computations. For example, Noise in quantum gates can propagate and accumulate as the computation progresses through the circuit. Qubit mapping can influence how errors accumulate, potentially leading to substantial inaccuracies in the final results. As another example, different qubits or gates can be more susceptible to noise than others. Mapping a qubit with higher sensitivity to an error-prone region of the hardware can result in increased error rates for the corresponding gates, affecting overall circuit performance.

Accordingly, systems or techniques that can address one or more of these technical problems can be desirable.

Various embodiments described herein can address one or more of these technical problems. One or more embodiments described herein can include systems, computer-implemented methods, apparatus, or computer program products that can facilitate sparse noise tomography-based qubit mapping. That is, various disadvantages associated with existing techniques for qubit mapping can be ameliorated by sparse noise tomography-based qubit mapping.

In various embodiments, a learning component can employ sparse tomography to learn noise of a quantum computing device to build a sparse noise model of the quantum computing device. Sparse qubit noise tomography is a method to characterize and measure noise present in qubits of a quantum system by utilizing a reduced set of measurements on the qubits. Noise affecting a quantum system is typically localized (e.g., sparse). That is, noise processes in quantum systems affect a limited set of quantum states or operation, and thus, causing noise sparsity. Sparse noise tomography leverages noise sparsity to characterize noise in quantum systems with a reduced set of measurements, allowing for quantum resource efficiency, reduced sensitivity to environmental noise, minimized complexity for mitigation of additional sources of error, and reliable characterization of quantum states. Thus, a selection component can retain, based on the sparse noise model and a quantum circuit, nodes and edges of a graph topology of the quantum computing device by removing selected qubits. A mapping component can then determine and obtain embedding layouts of graph fragments of the quantum computing device on of a graph of the quantum circuit. Thus, an optimal virtual-to-physical qubit mapping can be identified by the selection component based on a scoring of the graph fragments. Therefore, the methods employed herein can improve circuit execution quality by obtaining an efficient virtual-to-physical mapping that ensures available physical qubits arc utilized optimally. Furthermore, the methods employed herein can enable scalability of quantum computation to larger quantum circuits (e.g., more qubits) and provide improved algorithmic performance of quantum computation (e.g., faster computation, reduced noise effects, efficient utilization of quantum resources) by selecting a qubit mapping that maximizes performance and minimizes noise. Thus, the cost of run-time error mitigation techniques can also be reduced.

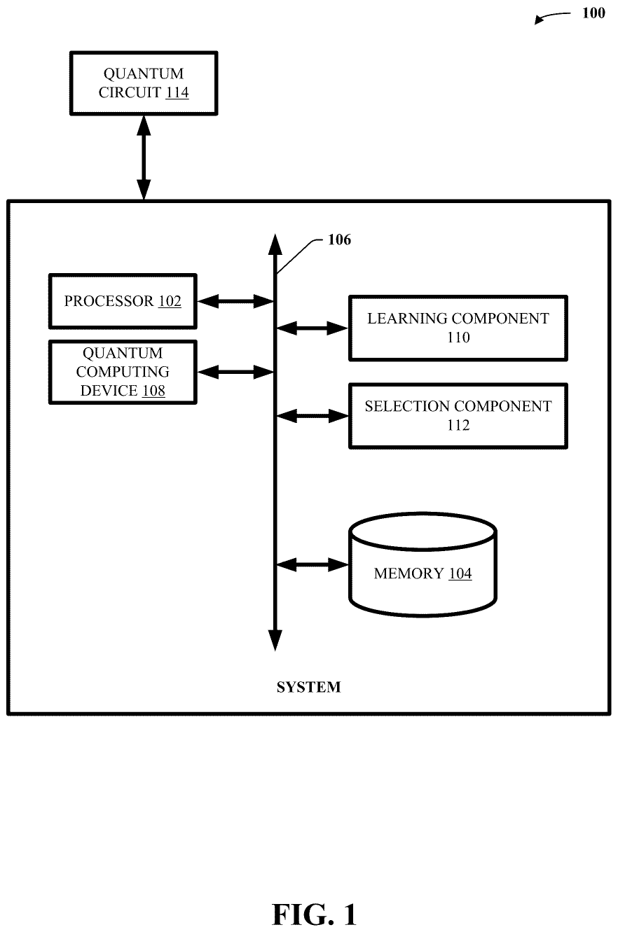

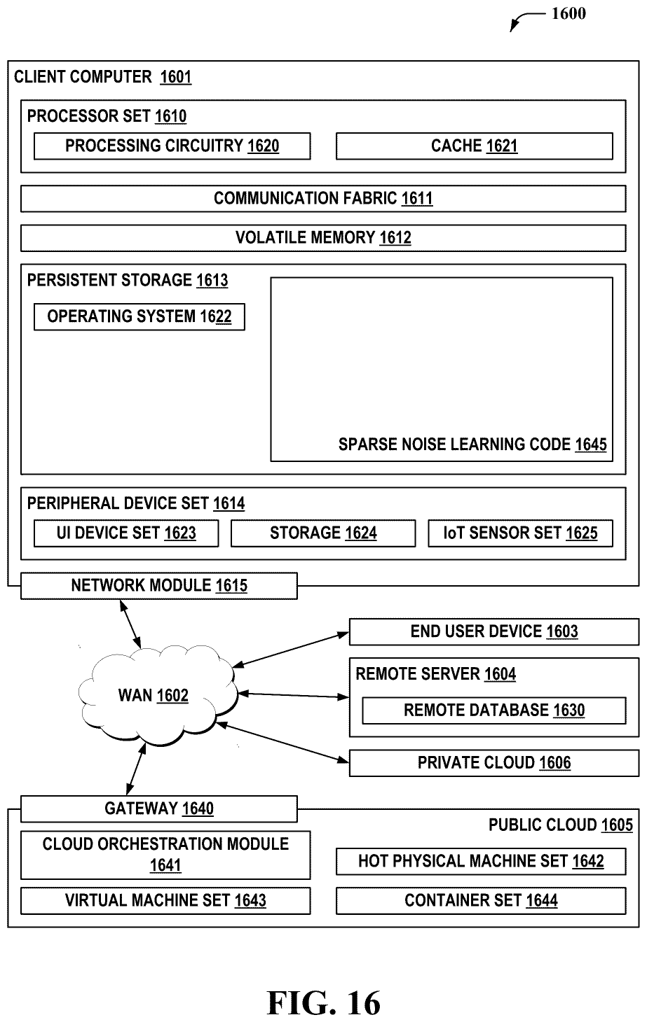

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated at FIG. 1, and/or systems thereof, can further comprise, be associated with and/or be coupled to one or more computer and/or computing-based elements described herein with reference to an operating environment, such as the operating environment 1600 illustrated in FIG. 16. For example, system 100 can be associated with, such as accessible via, a computing environment 1600 described below with reference to FIG. 16, such that aspects of processing can be distributed between system 100 and the computing environment 1600. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that can facilitate sparse noise tomography-based qubit mapping in accordance with one or more embodiments described herein. System 100 can comprise processor 102, memory 104, system bus 106, quantum computing device 108, learning component 110, and selection component 112.

The system 100 and/or the components of the system 100 can be employed to use hardware and/or software to solve problems that are highly technical in nature (e.g., qubit mapping, error mitigation of quantum circuits, etc.), that are not abstract and that cannot be performed as a set of mental acts by a human. Further, some of the processes performed may be performed by specialized computers for carrying out defined tasks related to performing sparse noise tomography on a graph topography of a quantum computing device. The system 100 and/or components of the system can be employed to solve new problems that arise through advancements in technology, computer networks, the Internet and the like. The system 100 can provide technical improvements to scalability of qubit mapping, quantum algorithmic execution performance, and/or obtaining optimal qubit mappings, etc.

Discussion turns briefly to processor 102, memory 104 and bus 106 of system 100. For example, in one or more embodiments, the system 100 can comprise processor 102 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 102 to enable performance of one or more processes defined by such component(s) and/or instruction(s).

In one or more embodiments, system 100 can comprise a computer-readable memory (e.g., memory 104) that can be operably connected to the processor 102. Memory 104 can store computer-executable instructions that, upon execution by processor 102, can cause processor 102 and/or one or more other components of system 100 (e.g., quantum computing device 108, learning component 110, and/or selection component 112) to perform one or more actions. In one or more embodiments, memory 104 can store computer-executable components (e.g., quantum computing device 108, learning component 110, and/or selection component 112).

System 100 and/or a component thereof as described herein, can be communicatively, electrically, operatively, optically and/or otherwise coupled to one another via bus 106. Bus 106 can comprise one or more of a memory bus, memory controller, peripheral bus, external bus, local bus, and/or another type of bus that can employ one or more bus architectures. One or more of these examples of bus 106 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

In addition to the processor 102 and/or memory 104 described above, system 100 can comprise one or more computer and/or machine readable, writable and/or executable components and/or instructions that, when executed by processor 102, can enable performance of one or more operations defined by such component(s) and/or instruction(s). For example, the learning component 110 can utilize sparse noise tomography to learn noise on a quantum computing device and generate a sparse noise model. Based on the sparse noise model, the selection component 112 can exclude qubits from a graph topology of the quantum computing device 108 from use in mapping a logical quantum circuit to physical qubits. In other words, selection component 112 may only create topologies with qubits having a threshold quality (e.g., by removing outlier qubits from the topology), and use such topologies for performing quantum circuits. Additional aspects of the one or more embodiments discussed herein are explained in greater detail with reference to subsequent figures. System 100 can be associated with, such as accessible via, a computing environment 1600 described below with reference to FIG. 16. For example, system 100 can be associated with a computing environment 1600 such that aspects of processing can be distributed between system 100 and the computing environment 1600.

In various embodiments, as described herein, the learning component 110 can employ sparse tomography (e.g., method to characterize and measure noise present in a quantum system by utilizing a reduced set of measurements on qubits) to learn noise of a quantum computing device 108 to build a sparse noise model of the quantum computing device 108. In various aspects, the sparse noise model can quantify characteristics of noise (e.g., amplitude) present in qubits or gates of the quantum computing device 108. The sparse noise model can be characterized by a set of parameters that can include, for example, rate, strength, or type of noise (e.g., dephasing, amplitude damping) to capture noise features of the quantum computing device 108.

In various embodiments, as described herein, the selection component 112 can retain, based on the sparse noise model and a quantum circuit 114, nodes and edges of a graph topology of the quantum computing device 108 by removing selected qubits.

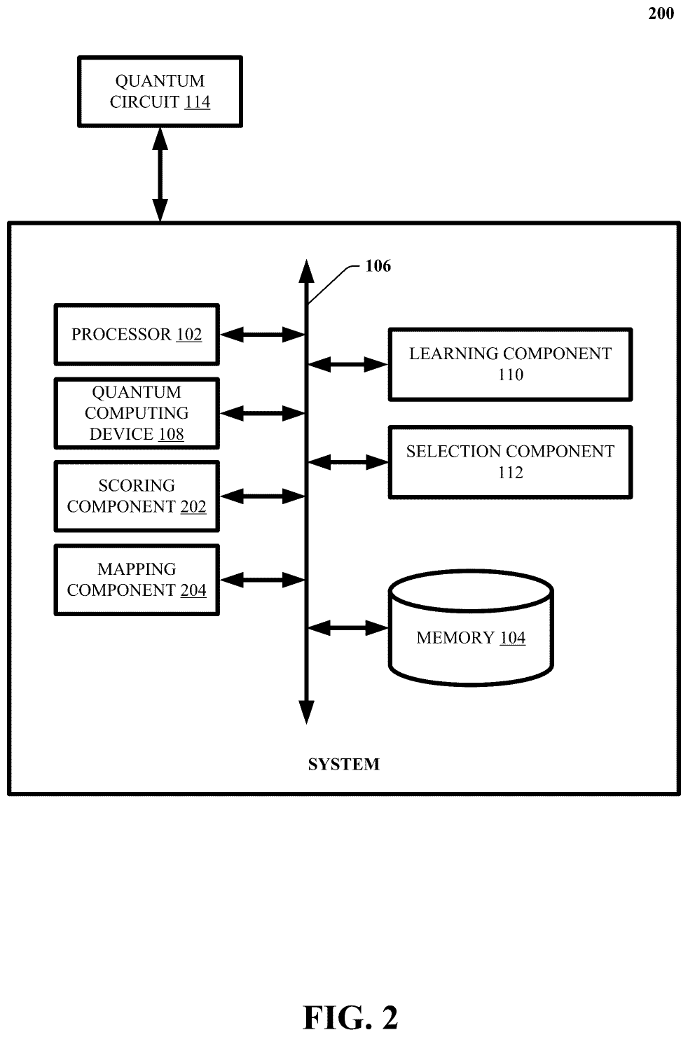

FIG. 2 illustrates a block diagram of an example, non-limiting system 200 that can facilitate sparse noise tomography-based qubit mapping in accordance with one or more embodiments described herein. As shown, the system 200 can comprise the same components as the system 100, and can further comprise a scoring component 202 and a mapping component 204.

In various embodiments, the scoring component 202 can employ cost functions that incorporate crosstalk, gate, state, and measurement noise to compute scores of nodes and edges in the graph topology of the quantum computing device 108. The scoring component 202 can utilize the sparse noise model generated by the learning component 110 to use learned noise amplitudes to compute the scores of the nodes and edges. In various aspects, the selection component 112 can utilize scores, computed by the scoring component 202, of nodes and edges of the graph topology of the quantum computing device 108 to determine which nodes (e.g., qubits) to remove or retain. Resulting from removal of qubits of the quantum computing device 108 by the selection component 112 are graph fragments to which the quantum circuit 114 can be embedded.

In various embodiments, the mapping component 204 can determine and obtain feasible embedding layouts of the fragments on a circuit graph. In other words, the mapping component 204 can obtain fragment embedding layouts of the quantum circuit 114 on the graph fragments of the quantum computing device 108 that support operations of the quantum circuit 114 (e.g., fragments contain adequate number of qubits, fragments comprise a suitable graph structure). In various aspects, the selection component 112 can determine which of the graph fragments of the quantum computing device 108 are able to embed the quantum circuit 114 into. Furthermore, the selection component 112 can engage the scoring component 202 to compute scores of remaining graph fragments to determine which graph fragment is an virtual-to-physical qubit mapping.

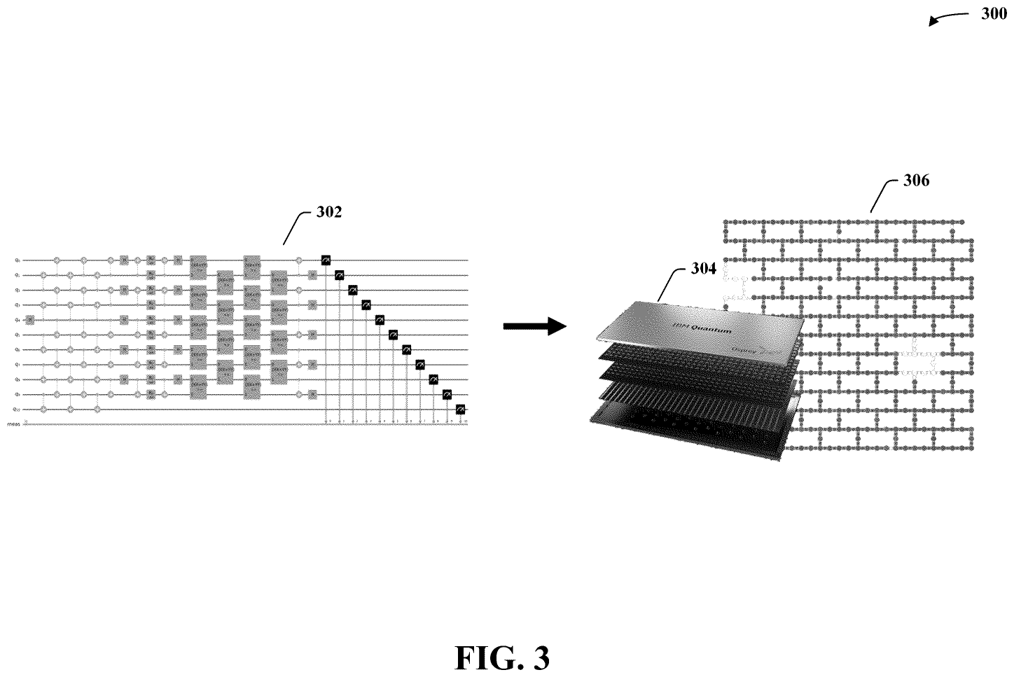

FIG. 3 illustrates an example, non-limiting representation of qubit mapping a quantum circuit onto a quantum computing device in accordance with one or more embodiments described herein.

In various aspects, a quantum circuit 302 can be mapped to physical qubits 306 on a quantum computing device 304. The quantum circuit 302 can exhibit any type of connectivity configuration between qubits (e.g., linear, all-to-all, ring). For example, quantum circuit 302 exhibits a linear connectivity between qubits. The quantum computing device 304 can share the same connectivity type as the quantum circuit 302 to enable qubit mapping from the quantum circuit 302 onto the physical qubits 306. The quantum circuit 302, in this example, contains 11 qubits to be mapped onto a subset of physical qubits 306, wherein selection of such physical qubits 306 can be based upon noise of the quantum computing device 304. For example, noise of the quantum computing device 304 can be learned through sparse noise tomography to select a subset of physical qubits 306 that minimizes effects of noise on the quantum circuit 302 (e.g., by selecting optimal qubits, optimizing quantum gate connectivity) to provide maximized algorithmic performance while considering multiple constraints (e.g., limited qubit resources, device connectivity limitations). Initial selection of minimal noise qubits can mitigate future need for noise reduction methods (e.g., error mitigation techniques). For example, by selecting qubits that already minimize noise, running the quantum circuit 302 a multitude of times for error mitigation can be avoided. Thus, additional quantum resources that would be used for error mitigation can be saved. Furthermore, sparse noise tomography to learn noise of quantum computing device 304 can be scaled to handle large quantities of qubits, quantities that can cause classical computing infrastructure to encounter performance bottlenecks.

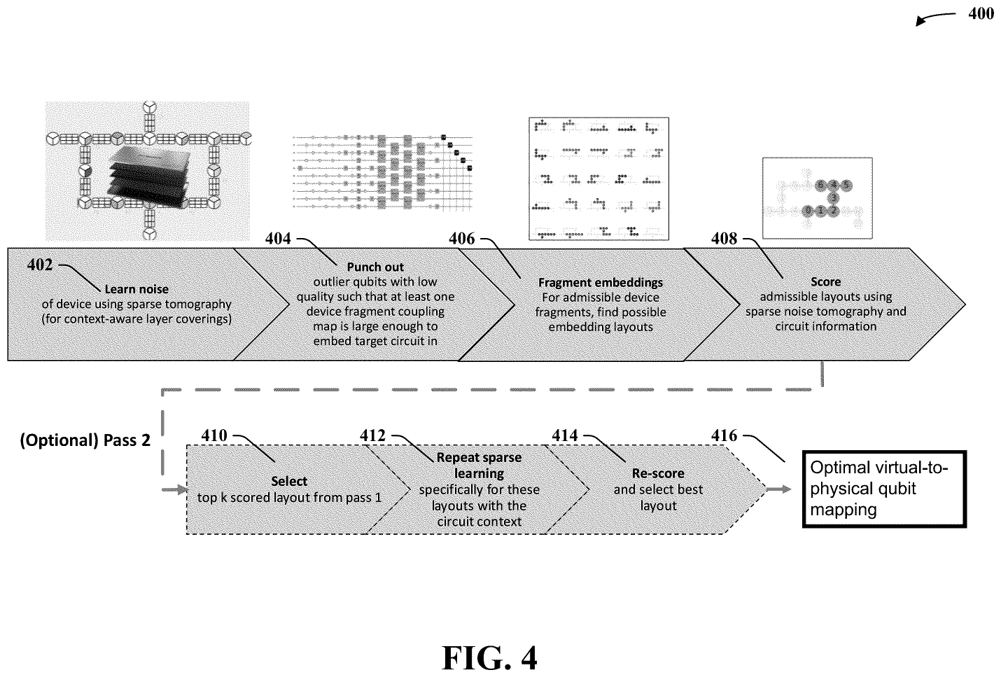

FIG. 4 illustrates an example, non-limiting representation sparse noise tomography-based qubit mapping in accordance with one or more embodiments described herein.

In various aspects, sparse noise tomography-based qubit mapping can comprise one sequence of steps and an optional second sequence of steps to obtain an optimal virtual-to-physical qubit mapping 416. The first sequence of steps can comprise learning noise 402, punching out 404, fragment embedding 406, and scoring 408. Learning noise 402 can comprise engaging the learning component 110 to learn noise of the quantum computing device 108 using sparse noise tomography. Punching out 404 can comprise engaging the selection component 112 to remove outlier qubits (e.g., qubits that exhibit an amount of noise that exceeds a defined threshold) from the graph topology of the quantum computing device 108 while retaining a subgraph of connected qubits (e.g., a fragment) having the same, or a higher, qubit count as the size of the quantum circuit 114. For example, if the quantum circuit 114 contains five qubits in total, the selection component 112 can continue removing qubits providing at least one fragment containing five qubits of the quantum computing device 108 remains. Fragment embedding 406 can engage the mapping component 204 to determine possible embedding layouts of the quantum circuit 114 on remaining qubit fragments of the quantum computing device 108. Scoring 408 can engage the scoring component 202 to compute and assign scores to the possible embedding fragments based on learned noise from sparse noise tomography and information of the quantum circuit 114.

In various embodiments, if further accurate learning of noise is desired, the optional second sequence of steps can be performed. The second sequence of steps can comprise a selection 410, sparse learning 412, and rescoring 414 to obtain the optimal virtual-to-physical qubit mapping 416. Selection 410 can comprise engaging the selection component 112 to select a subset of size k of possible embedding fragments based on minimum scores computed from scoring 408. Sparse learning 412 can comprise engaging the learning component 110 to reperform sparse learning on the fragment embedding layouts, determined in fragment embedding 406, within context of the quantum circuit 114. Rescoring 414 can comprise engaging the scoring component 202 to rescore the fragment embedding layouts based on relearned noise. Rescoring 414 can further comprise engaging the selection component 112 to select the optimal virtual-to-physical qubit mapping 416 based on the minimum rescore of embedding fragments.

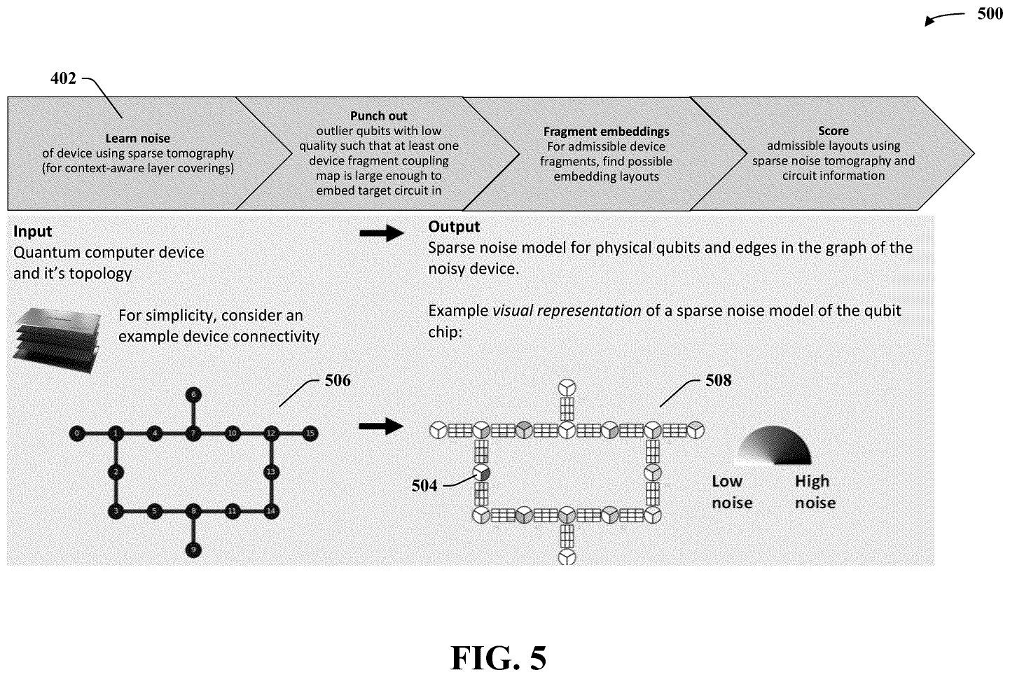

FIG. 5 illustrates an example, non-limiting representation of sparse noise tomography on a quantum computing device in accordance with one or more embodiments described herein.

In various embodiments, learning noise 402 can comprise receiving as input a graph topology 506 of quantum computing device 108, and generate a sparse noise model 508 of physical qubits in the graph topology. For example, the learning component 110 can perform sparse noise tomography on graph topography 506 to learn noise of the quantum computing device 108 and produce the sparse noise model 508. Depicted in sparse noise model 508, for example, qubit 504 contains high noise and therefore can be removed by the selection component 112 during qubit removal of the quantum computing device 108. Furthermore, executing sparse noise tomography on the quantum computing device 108 is scalable, meaning learning noise of the physical qubits remains efficient and manageable on quantum computing devices containing larger numbers of qubits. Moreover, the learning component 110 can utilize Pauli-Lindblad noise model learning in optimization of the sparse noise model 508 by correcting quantum errors or mitigating quantum errors.

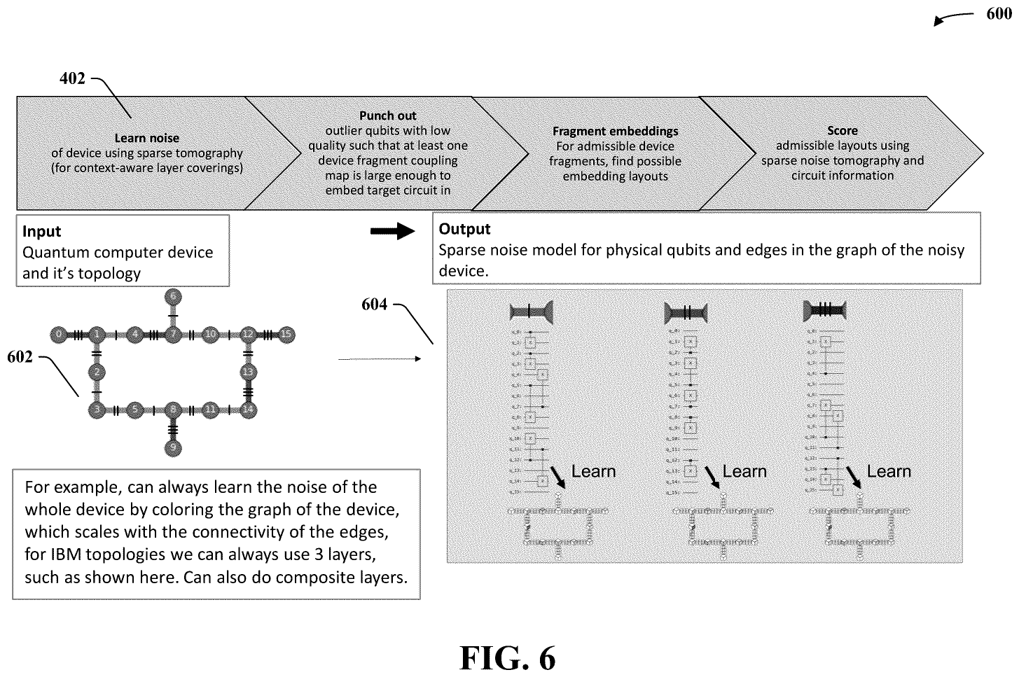

FIG. 6 illustrates an example, non-limiting representation of balanced coloring for noise learning or a quantum computing device in accordance with one or more embodiments described herein.

In various embodiments, the learning component 110 can utilize balanced coloring in learning noise of the quantum computing device 108. For example, graph topology 602 can be divided into three colors (e.g., layers), depicted in graph topology 602 by different dashes, wherein qubit gates of the same group can be executed simultaneously. Furthermore, composite layers can also be utilized in dividing of graph connectivity. Assignment of colors (e.g., groups) can be determined by a constraint that a qubit can not be involved in execution of more than one qubit gate at a time. For example, if a qubit is connected by two qubit gates of the same group, when all qubit gates of one group are executed, the two qubit gates will be unable to run simultaneously on the same qubit. In other words, a qubit can not be connected to more than one qubit gate of a same group. For the example graph topology 602 or graph topologies of similar connectivity, three colors can be used, meaning learning of noise of the quantum computing device 108 will occur three times, as depicted in 604. Furthermore, the number of colors used is independent of size of graph topology (e.g., number of qubits) of the quantum computing device 108. Thus, three-coloring division of any size quantum computing device 108 can performed, wherein total cost of learning noise of the quantum computing device 108, although with an increase in qubit gates running simultaneously, remains unchanged with differences in size.

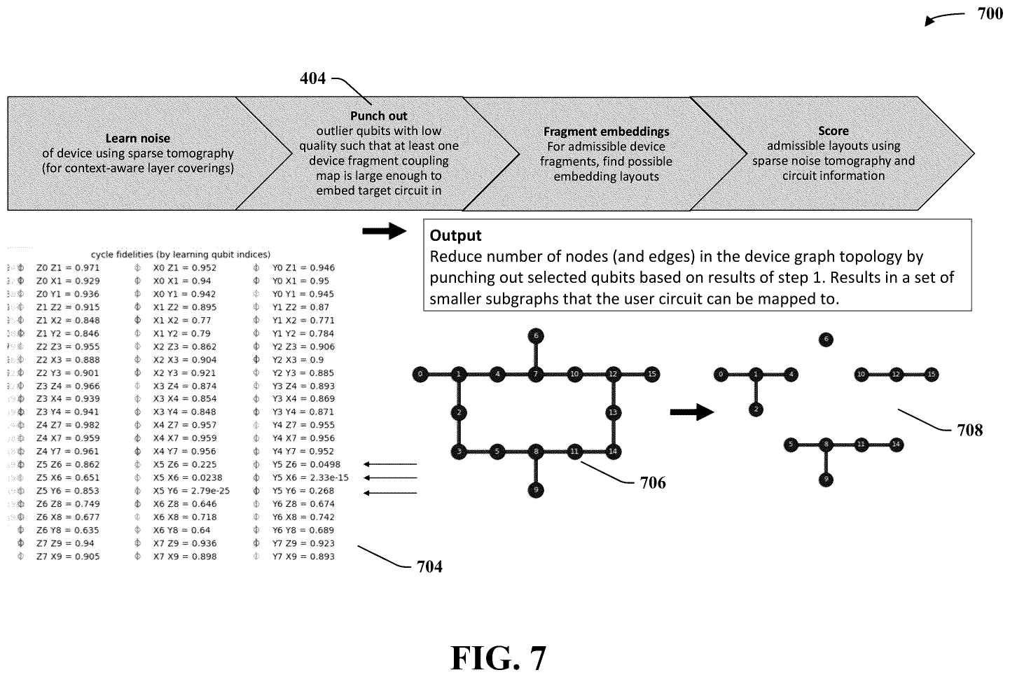

FIG. 7 illustrates an example, non-limiting representation of qubit selection of a quantum computing device in accordance with one or more embodiments described herein.

In various embodiments, punching out 404 can comprise receiving an input graph topology 706 of the quantum computing device 108 and produce a set of subgraphs 708 that the quantum circuit 114 can be mapped to. In various embodiments, the selection component 112 can reduce a number of nodes and edges of input graph topology 706 by selecting qubits to exclude based on noise learned in the sparse noise model 508. For example, graph topology 706 can result in four subgraphs after removal of qubits by the selection component 112.

In various aspects, the selection component 112 can identify outlier qubits to remove based on a defined threshold. If measures of qubit properties exceed the determined thresholds, the selection component 112 can identify that qubit as an outlier and exclude it from the graph topology 706. Thus, the quantity of subgraphs 708 can be minimized, causing a reduction in number of mapping combinations of quantum circuit 114 to quantum computing device 108. Furthermore, cycle fidelities 704 can be computed for quantum gates of the quantum computing device 108 to determine accuracy and performance if the quantum gates. For example, the selection component 112 can use such set of fidelities in determining which qubits to remove from the quantum computing device 108.

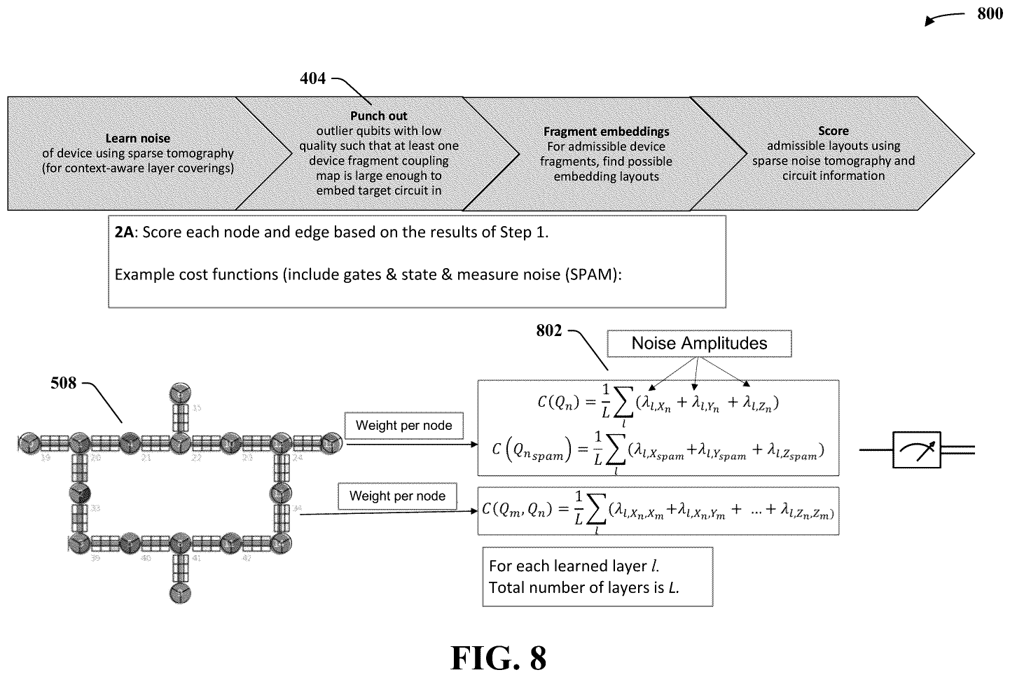

FIG. 8 illustrates an example, non-limiting representation of scoring nodes and edges for qubit selection of a quantum computing device in accordance with one or more embodiments described herein.

In various embodiments, the scoring component 202 can employ cost functions 802 of learned noise amplitudes from sparse noise model 508 for each node and edge. For example, cost functions 802 can compute weights for each node and edge for each learned layer l of total layers L, where noise amplitude is denoted by A. More specifically, the cost functions 802 can include state preparation and measurement errors and qubit gate errors in characterization of noise. State preparation and measurement errors (e.g., readout errors) are noise that can affect measurement outcomes of the quantum computing device 108. State preparation errors are deviations from intended states of qubits from imperfections in operations used to initialize qubits in a specific state. Measurement errors are deviations in measurements of quantum states. Furthermore, qubit gate errors are inaccuracies that occur during execution of quantum gate operations. For example, crosstalk (e.g., undesired interactions between qubits or quantum gates from physical proximity of qubits or hardware imperfections) can cause errors in gate operations. Moreover, cost functions 802 can also include bit flip errors that occur, wherein the state of a qubit flips (e.g., 0 is read instead of 1, 1 is read instead of 0). Thus, cost functions 802 can include such errors of qubits and qubit connections, from which the selection component 112 can compute a score for each qubit in the quantum computing device 108.

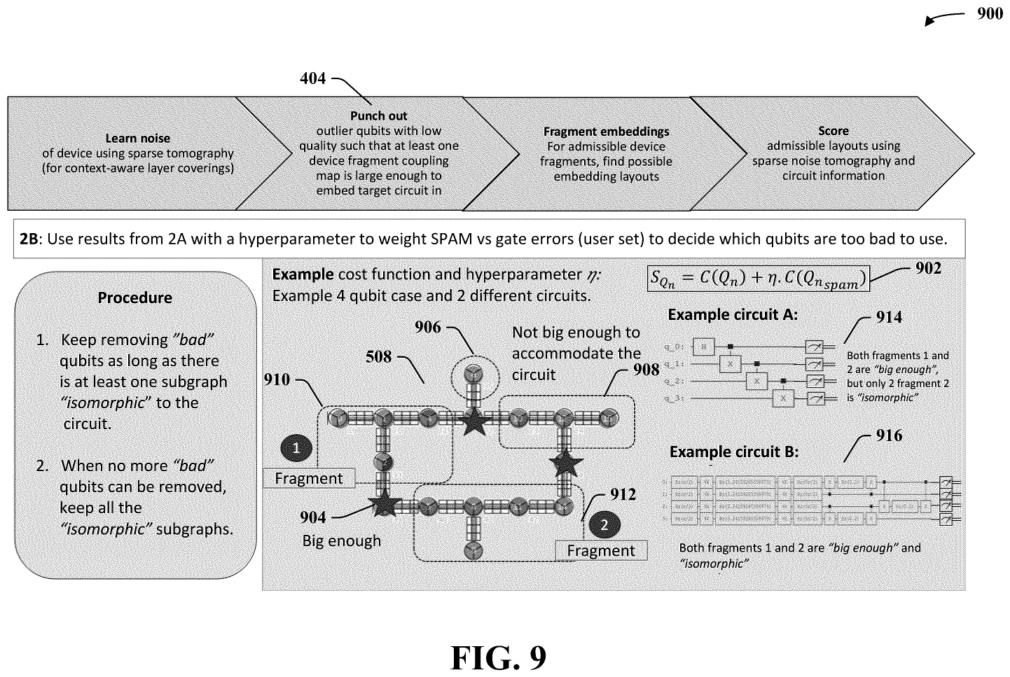

FIG. 9 illustrates an example, non-limiting representation of qubit selection of a quantum computing device in accordance with one or more embodiments described herein.

In various embodiments, the selection component 112 can engage the scoring component 202 to determine which nodes and edges to exclude from the resulting set of subgraphs 708. More specifically, the scoring component 202 can use the cost functions 802 and a hyperparameter n to weight state preparation and measurement errors against gate errors (e.g., can be set by a user) and compute scores, defined by score function 902, for qubits in the graph topology 508. Thus, the scoring component 112 can select qubits to exclude based on the computed scores.

In various aspects, the selection component 112 can continuously remove qubits that are assigned scores below a defined threshold so long as at least one subgraph is isomorphic to the quantum circuit 114 (e.g., at least one subgraph shares an underlying graph structure with the quantum circuit 114) remains. From the remaining subgraphs after qubit removal, the selection component 112 can retain all subgraphs that are isomorphic to the quantum circuit. For example, the selection component 112 can remove three qubits 904 from graph topology 508, resulting in four remaining subgraphs for a circuit 914 and a circuit 916, wherein circuit 914 and circuit 916 comprise four qubits. Thus, the selection component 112 can omit subgraph 906 and subgraph 908 because subgraph 906 contains one qubit and subgraph 908 contains three qubits, as they do not comprise enough qubits to accommodate a four-qubit circuit. In other words, a four-qubit circuit can't be mapped onto a single qubit or three qubits. Conversely, subgraph 910 comprises four qubits and subgraph 912 comprises five qubits, and thus contain enough qubits to accommodate mapping of circuit 914 and circuit 916. Furthermore, from a subset of subgraphs that contain the same or more qubits than the quantum circuit 114, the selection component 112 can ensure the subgraphs comprise a connectivity that can support operations of the quantum circuit 114. For example, only subgraph 912 is isomorphic to circuit 914. Therefore, the selection component 112 can retain subgraph 912 for embedding circuit 914. With respect to circuit 916, both subgraph 910 and subgraph 912 are isomorphic to circuit 916. Therefore, the selection component 112 can retain subgraph 910 and subgraph 912 as possible embedding layouts for circuit 916.

In various aspects, if no isomorphic subgraphs remain after removing qubits, the selection component 112 can lower the thresholds used to determine if a qubit is and outlier. Qubits that had been removed can be reincluded until a subgraph that is isomorphic to the quantum circuit 114 is present.

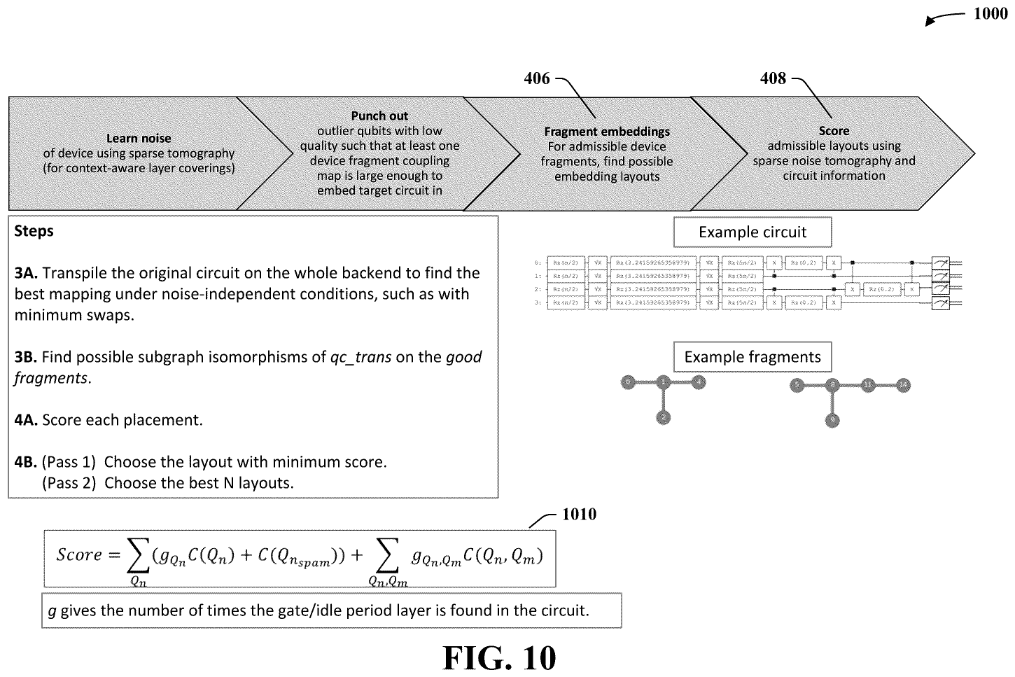

FIG. 10 illustrates an example, non-limiting representation of scoring nodes and edges for qubit selection of a quantum computing device in accordance with one or more embodiments described herein.

In various embodiments, fragment embedding 406 can comprise obtaining graph fragment layouts that the quantum circuit 114 can be mapped to subgraphs 708 retained by the selection component 112. More specifically, the mapping component 204 can transpile the quantum circuit 114 onto the quantum computing component 108 (e.g., transform or compile a quantum circuit into a format that is suitable for execution on a specific quantum computing device) under noise-independent conditions (e.g., minimum swaps). After transpiling the quantum circuit 114, the mapping component can obtain feasible subgraph isomorphisms of the transpiled quantum circuit 114 on the output of retained fragments by executing punching out 404.

In various embodiments, scoring 408 can comprise engaging the scoring component 202 to score each layout of subgraph isomorphisms obtained by the mapping component 204. The scoring component 202 can utilize cost functions 802 in score function 1010 to compute a score for each embedding layout based on measurements of qubit gate noise and the number of times each operation appears in the quantum circuit 114. If only one pass is desired by a user, the selection component 112 can select an embedding layout with the minimum score as the optimal virtual-to-physical qubit mapping 416. If two passes are desired by a user, the selection component 112 can select a subset of size N of embedding layouts with lowest scores.

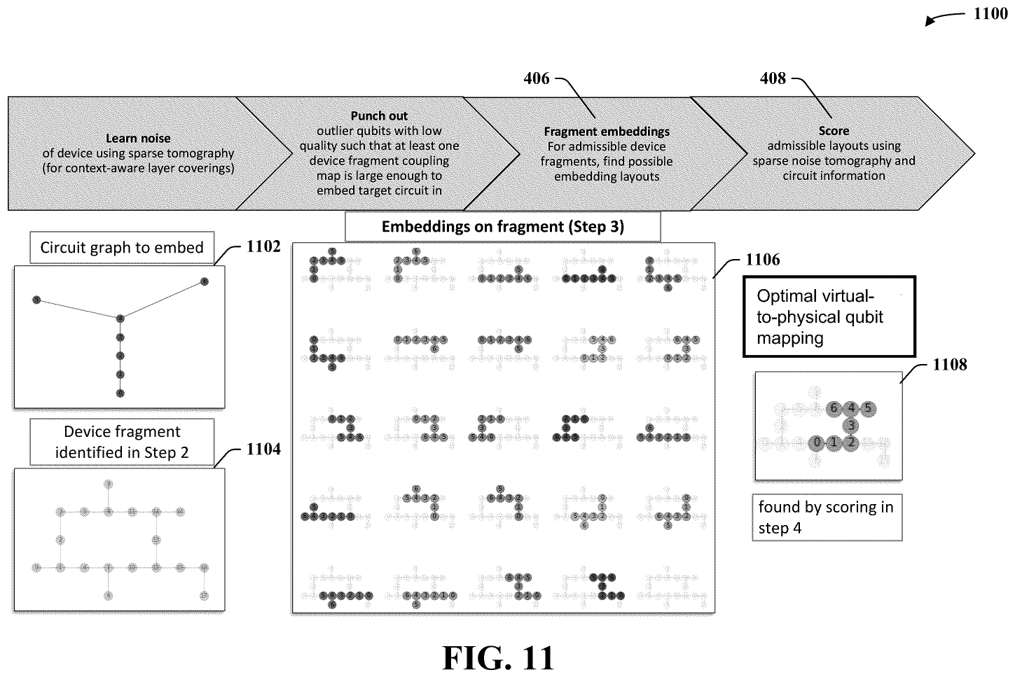

FIG. 11 illustrates an example, non-limiting representation of obtaining, scoring, and selecting embedding layouts in accordance with one or more embodiments described herein.

As an example of obtaining, scoring, and selecting an embedding layout, a quantum circuit 114 can be represented by a circuit graph 1102, wherein each node depicts a qubit. A fragment of the quantum computing device 108 identified in punching out 404 can be represented by fragment graph 1104. The mapping component 204 can determine and obtain a set of all embedding layouts 1106 of the circuit graph 1102 on the fragment graph 1104, such that connectivity of qubits (e.g., graph shape, graph structure) of embedding layouts 1106 match connectivity of qubits of circuit graph 1102 to support operations of the quantum circuit 114. Thus, the scoring component 202 can compute a score using cost functions 802 for each embedding layout 1106 to determine an optimal qubit mapping based on noise measurements of each graph node and edge. Based on the computed scores of each embedding layout 1106, the selection component 112 can select an optimal virtual-to-physical qubit mapping 1108 that has the minimum computed score of all embedding layouts 1106.

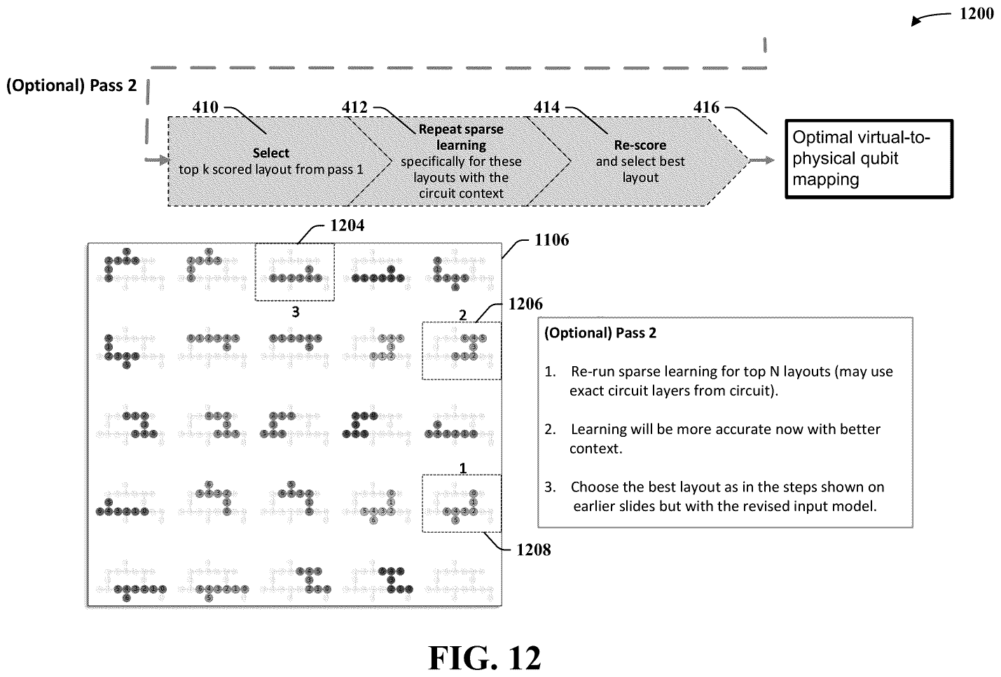

FIG. 12 illustrates an example, non-limiting representation of relearning, rescoring, and selecting a set of embedding layouts in accordance with one or more embodiments described herein.

In various embodiments, if further refinement in selection of optimal qubit mapping layouts is desired, the selection component 112 can select a subset of embedding layouts as optimal qubit mappings. For example, the selection component 112 can select a subset of N embedding layouts 1106 that comprise layout 1204, layout 1206, and layout 1208. Thus, the learning component 110 can perform sparse noise learning a second time on the subset of embedding layouts 1106 (e.g., on layout 1204, layout 1206, and layout 1208). Furthermore, sparse learning on the subset of embedding layouts can utilize exact circuit layers from the quantum circuit 114. Moreover, performing a second sparse learning can enable more accurate learning of noise because of further known context of the quantum circuit 114 from the first sequence of sparse learning 412. Thus, computed scores of the subset of the three embedding layouts can comprise further accurate noise amplitudes and enable further accurate selection of the optimal virtual-to-physical qubit mapping by the selection component 112. For example, before a second sparse learning, layout 1206 can have the minimum score, however, after performing a second sparse learning, layout 1204 can have the minimum score, therefore being the optimal virtual-to-physical qubit mapping.

In various embodiments, the learning component 110 can learn noise of specific edges instead of all edges of the quantum computing device 108. More specifically, noise can be learned for only edges that appear in a particular fragment of the quantum computing device 108.

Thus, minimal noise is caused during learning because noise caused by running a multitude of operation simultaneously is prevented, enabling further accurate learning of noise within the quantum computing device 108.

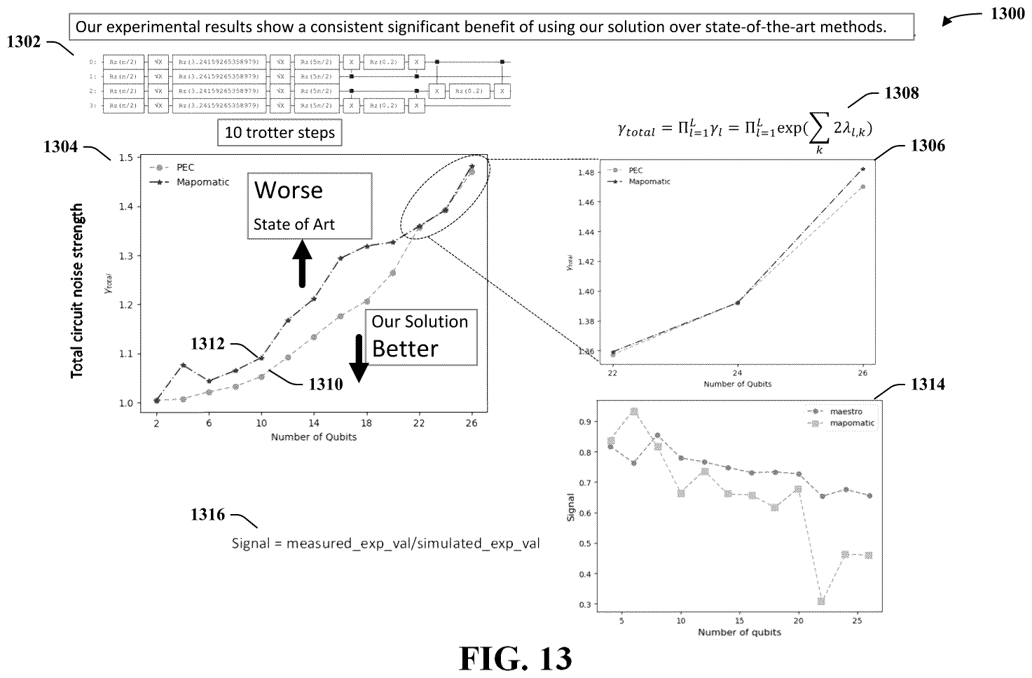

FIG. 13 illustrates an example, non-limiting plot of experimental results on a quantum circuit in accordance with one or more embodiments described herein.

In various embodiments, there can be quantum circuit 1302 containing 10 time evolution steps. Plot 1304 depicts the cost of embedding layouts determined by sparse noise tomography-based qubit mapping 1310 against other qubit mapping method 1312 (e.g., Mapomatic) by plotting number of qubits against total circuit noise strength. Total noise strength of embedding layouts can be defined by equation 1308. As shown in plot 1304, the herein proposed method for sparse noise tomography-based qubit mapping 1310 outperforms the other qubit mapping method 1312. The sparse noise tomography-based qubit mapping method outperforms (e.g., comprises less total circuit noise strength) for circuits comprising a low number of qubits. Furthermore, plot 1306 depicts a portion of plot 1304 of total circuit noise for circuits comprising a large number of qubits. Although limited mapping layouts exist for circuits comprising a large number of qubits, the herein proposed method for qubit mapping still provides slightly less total circuit noise strength than the other qubit mapping method. Moreover, plot 1314 depicts the number of qubits against signal, wherein signal is defined by equation 1316, for sparse noise tomography-based qubit mapping 1310 and qubit mapping method 1312. As shown in plot 1314, sparse noise tomography-based qubit mapping 1310 outperforms qubit mapping method 1312 in performance accuracy by exhibiting higher accuracy of simulated values for measured experiment values.

Furthermore, sparse noise tomography-based qubit mapping utilizes only three parameters to characterize errors (e.g., depths, twirls, shots) during experiment, a reduction from other qubit mapping methods, wherein depth denotes the depth of learning, twirls is the number of instances, and shots is the number of executions. Such a reduction in parameters can enable compact solutions, easy manipulation, and simpler comparison of quantum computing devices with noise sources with a single experiment.

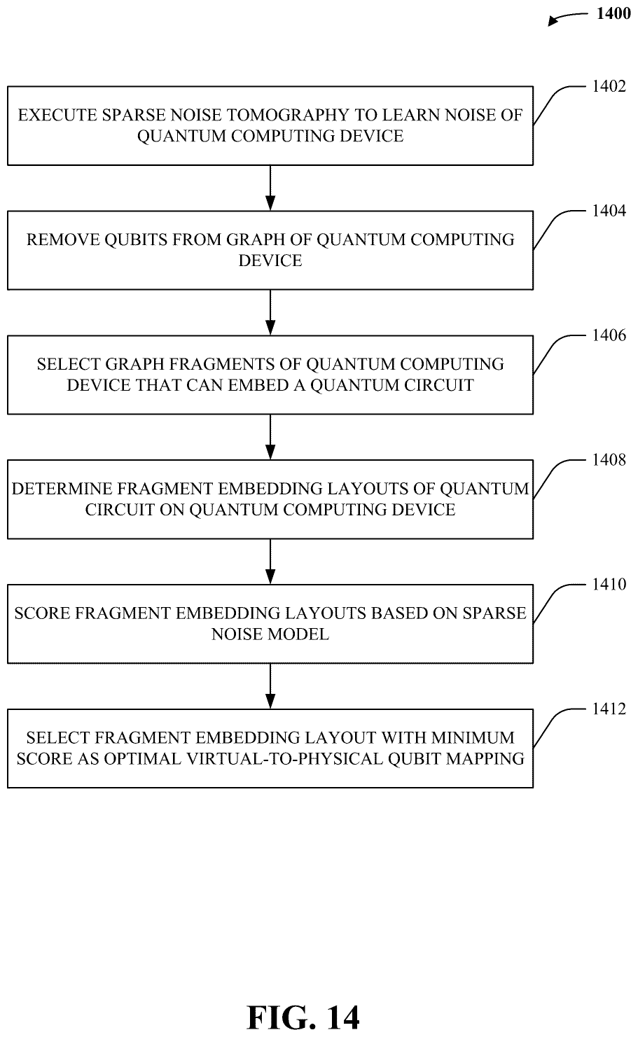

FIG. 14 illustrates a flow diagram of an example, non-limiting method 1400 of facilitating sparse noise tomography-based qubit mapping in accordance with one or more embodiments described herein.

At 1402, the non-limiting method 1400 can comprise executing (e.g., by the learning component 110), by the system, sparse noise tomography to learn noise of the quantum computing device 108.

At 1404, the non-limiting method 1400 can comprise removing (e.g., by the selection component 112), by the system, qubits from a graph of the quantum computing device 108.

At 1406, the non-limiting method 1400 can comprise selecting (e.g., by the computation component 112), by the system, graph fragments of the quantum computing device 108 that can embed the quantum circuit 114.

At 1408, the non-limiting method 1400 can comprise determining (e.g., by the mapping component 204), by the system, fragment embedding layouts of the quantum circuit 114 on the quantum computing device 108.

At 1410, the non-limiting method 1400 can comprise scoring (e.g., by the scoring component 202), by the system, the fragment embedding layouts based on a sparse noise model.

At 1412, the non-limiting method 1400 can comprise selecting (e.g., by the selection component 112), by the system, a fragment embedding layout with a minimum score as an optimal virtual-to-physical qubit mapping.

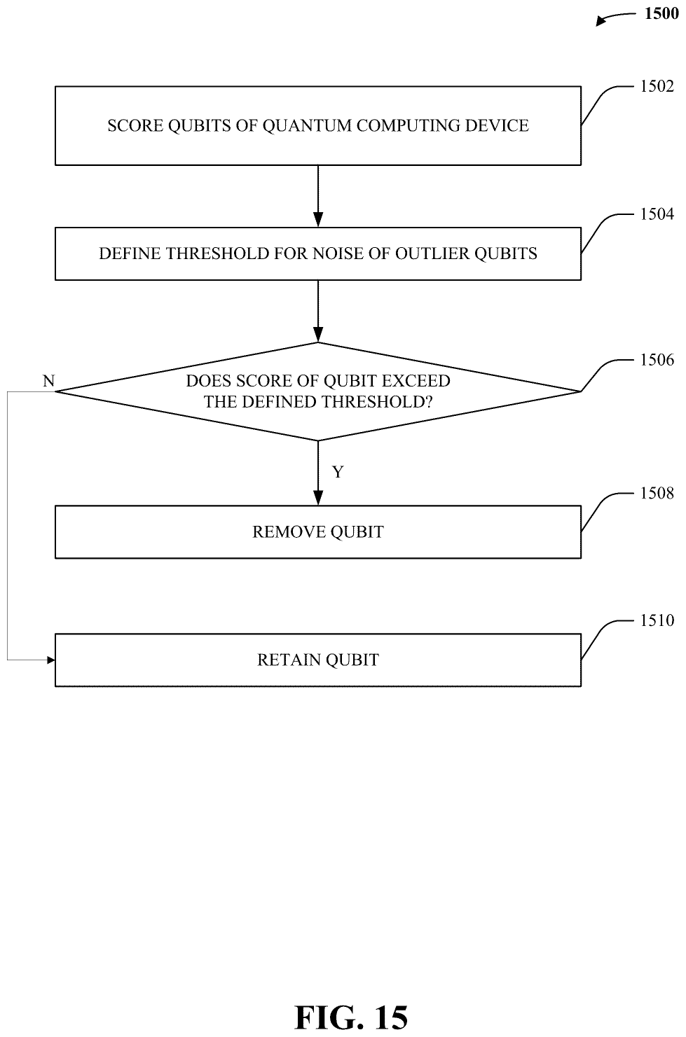

FIG. 15 illustrates a flow diagram of an example, non-limiting method 1500 of facilitating sparse noise tomography-based qubit mapping in accordance with one or more embodiments described herein. Repetitive description of like elements and/or processes employed in respective embodiments is omitted for sake of brevity.

At 1502, the non-limiting method 1500 can comprise scoring (e.g., by the scoring component 202), by the system, qubits of a quantum computing component 108.

At 1504, the non-limiting method 1500 can comprise defining (e.g., by the selection component 112), by the system, a threshold for noise of outlier qubits.

At 1506, the non-limiting method 1500 can determine if the score of the qubit exceeds the defined threshold for noise. If yes, the non-limiting method 1500 can remove, at 1508, the qubit. If no, the non-limiting method 1500 can proceed to 1510.

At 1508, the non-limiting method 1500 can comprise retaining (e.g., by the selection component 112), by the system, the qubit.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively perform qubit mapping with sparse noise tomography as the one or more embodiments described herein can enable this process. And, neither can the human mind nor a human with pen and paper perform qubit mapping with sparse noise tomography, as conducted by one or more embodiments described herein.

FIG. 16 illustrates a block diagram of an example, non-limiting, operating environment in which one or more embodiments described herein can be facilitated. FIG. 16 and the following discussion are intended to provide a general description of a suitable operating environment 1600 in which one or more embodiments described herein at FIGS. 1-15 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1600 contains an example of an environment for the execution of at least some of the computer code involved in performing the inventive methods, such as sparse noise learning code 1645. In addition to block 1645, computing environment 1600 includes, for example, computer 1601, wide area network (WAN) 1602, end user device (EUD) 1603, remote server 1604, public cloud 1605, and private cloud 1606. In this embodiment, computer 1601 includes processor set 1610 (including processing circuitry 1620 and cache 1621), communication fabric 1611, volatile memory 1612, persistent storage 1613 (including operating system 1622 and block 1645, as identified above), peripheral device set 1614 (including user interface (UI), device set 1623, storage 1624, and Internet of Things (IoT) sensor set 1625), and network module 1615. Remote server 1604 includes remote database 1630. Public cloud 1605 includes gateway 1640, cloud orchestration module 1641, host physical machine set 1642, virtual machine set 1643, and container set 1644.

COMPUTER 1601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1630. As is well understood in the art of computer technology, and depending upon the technology, performance of a computer-implemented method may be distributed among multiple computers and/or between multiple locations. On the other hand, in this presentation of computing environment 1600, detailed discussion is focused on a single computer, specifically computer 1601, to keep the presentation as simple as possible. Computer 1601 may be located in a cloud, even though it is not shown in a cloud in FIG. 12. On the other hand, computer 1601 is not required to be in a cloud except to any extent as may be affirmatively indicated.

PROCESSOR SET 1610 includes one, or more, computer processors of any type now known or to be developed in the future. Processing circuitry 1620 may be distributed over multiple packages, for example, multiple, coordinated integrated circuit chips. Processing circuitry 1620 may implement multiple processor threads and/or multiple processor cores. Cache 1621 is memory that is located in the processor chip package(s) and is typically used for data or code that should be available for rapid access by the threads or cores running on processor set 1610. Cache memories are typically organized into multiple levels depending upon relative proximity to the processing circuitry. Alternatively, some, or all, of the cache for the processor set may be located “off chip.” In some computing environments, processor set 1610 may be designed for working with qubits and performing quantum computing.

Computer readable program instructions are typically loaded onto computer 1601 to cause a series of operational steps to be performed by processor set 1610 of computer 1601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1621 and the other storage media discussed below. The program instructions, and associated data, are accessed by processor set 1610 to control and direct performance of the inventive methods. In computing environment 1600, at least some of the instructions for performing the inventive methods may be stored in block 1645 in persistent storage 1613.

COMMUNICATION FABRIC 1611 is the signal conduction paths that allow the various components of computer 1601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1612 is any type of volatile memory now known or to be developed in the future. Examples include dynamic type random access memory (RAM) or static type RAM. Typically, the volatile memory is characterized by random access, but this is not required unless affirmatively indicated. In computer 1601, the volatile memory 1612 is located in a single package and is internal to computer 1601, but, alternatively or additionally, the volatile memory may be distributed over multiple packages and/or located externally with respect to computer 1601.

PERSISTENT STORAGE 1613 is any form of non-volatile storage for computers that is now known or to be developed in the future. The non-volatility of this storage means that the stored data is maintained regardless of whether power is being supplied to computer 1601 and/or directly to persistent storage 1613. Persistent storage 1613 may be a read only memory (ROM), but typically at least a portion of the persistent storage allows writing of data, deletion of data and re-writing of data. Some familiar forms of persistent storage include magnetic disks and solid state storage devices. Operating system 1622 may take several forms, such as various known proprietary operating systems or open source Portable Operating System Interface type operating systems that employ a kernel. The code included in block 1645 typically includes at least some of the computer code involved in performing the inventive methods.

PERIPHERAL DEVICE SET 1614 includes the set of peripheral devices of computer 1601. Data communication connections between the peripheral devices and the other components of computer 1601 may be implemented in various ways, such as Bluetooth connections, Near-Field

Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1623 may include components such as a display screen, speaker, microphone, wearable devices (such as goggles and smart watches), keyboard, mouse, printer, touchpad, game controllers, and haptic devices. Storage 1624 is external storage, such as an external hard drive, or insertable storage, such as an SD card. Storage 1624 may be persistent and/or volatile. In some embodiments, storage 1624 may take the form of a quantum computing storage device for storing data in the form of qubits. In embodiments where computer 1601 is required to have a large amount of storage (for example, where computer 1601 locally stores and manages a large database) then this storage may be provided by peripheral storage devices designed for storing very large amounts of data, such as a storage area network (SAN) that is shared by multiple, geographically distributed computers. IoT sensor set 1625 is made up of sensors that can be used in Internet of Things applications. For example, one sensor may be a thermometer and another sensor may be a motion detector.

NETWORK MODULE 1615 is the collection of computer software, hardware, and firmware that allows computer 1601 to communicate with other computers through WAN 1602. Network module 1615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1615 are performed on the same physical hardware device. In other embodiments (for example, embodiments that utilize software-defined networking (SDN)), the control functions and the forwarding functions of network module 1615 are performed on physically separate devices, such that the control functions manage several different network hardware devices. Computer readable program instructions for performing the inventive methods can typically be downloaded to computer 1601 from an external computer or external storage device through a network adapter card or network interface included in network module 1615.

WAN 1602 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1603 is any computer system that is used and controlled by an end user (for example, a customer of an enterprise that operates computer 1601), and may take any of the forms discussed above in connection with computer 1601. EUD 1603 typically receives helpful and useful data from the operations of computer 1601. For example, in a hypothetical case where computer 1601 is designed to provide a recommendation to an end user, this recommendation would typically be communicated from network module 1615 of computer 1601 through WAN 1602 to EUD 1603. In this way, EUD 1603 can display, or otherwise present, the recommendation to an end user. In some embodiments, EUD 1603 may be a client device, such as thin client, heavy client, mainframe computer, desktop computer and so on.

REMOTE SERVER 1604 is any computer system that serves at least some data and/or functionality to computer 1601. Remote server 1604 may be controlled and used by the same entity that operates computer 1601. Remote server 1604 represents the machine(s) that collect and store helpful and useful data for use by other computers, such as computer 1601. For example, in a hypothetical case where computer 1601 is designed and programmed to provide a recommendation based on historical data, then this historical data may be provided to computer 1601 from remote database 1630 of remote server 1604.

PUBLIC CLOUD 1605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 1605 is performed by the computer hardware and/or software of cloud orchestration module 1641. The computing resources provided by public cloud 1605 are typically implemented by virtual computing environments that run on various computers making up the computers of host physical machine set 1642, which is the universe of physical computers in and/or available to public cloud 1605. The virtual computing environments (VCEs) typically take the form of virtual machines from virtual machine set 1643 and/or containers from container set 1644. It is understood that these VCEs may be stored as images and may be transferred among and between the various physical machine hosts, either as images or after instantiation of the VCE. Cloud orchestration module 1641 manages the transfer and storage of images, deploys new instantiations of VCEs and manages active instantiations of VCE deployments. Gateway 1640 is the collection of computer software, hardware, and firmware that allows public cloud 1605 to communicate through WAN 1602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1606 is similar to public cloud 1605, except that the computing resources are only available for use by a single enterprise. While private cloud 1606 is depicted as being in communication with WAN 1602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1605 and private cloud 1606 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the afore described computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a processor that executes computer-executable components stored in a non-transitory computer-readable memory, the computer-executable components comprising:
a quantum computing device;
a learning component that employs sparse tomography to learn noise of the quantum computing device to build a sparse noise model of the quantum computing device; and
a selection component that selects, for performing a quantum circuit, nodes and edges of a graph topology of the quantum computing device meeting a threshold quality.

2. The system of claim 1, wherein the system further comprises a scoring component that scores, based on the sparse noise model, each node and edge of the graph topology.

3. The system of claim 2, wherein the score component employs cost functions that incorporate crosstalk, gate, state, and measurement noise to compute scores of the nodes and edges.

4. The system of claim 3, wherein the learning component employs balanced coloring of the quantum computing device graph topology in layers or composite layers to learn the noise of the of the quantum computing device.

5. The system of claim 2, wherein the selection component weights, based on the computed scores of each node and edge of the graph topology from the sparse noise model, gate errors against state preparation and measurement errors to determine qubits to remove.

6. The system of claim 1, wherein the learning component utilizes Pauli-Lindblad noise model learning in optimization of learning the noise model of the quantum computing device.

7. The system of claim 1, wherein the selection component removes qubits from use as long as at least one subgraph isomorphic to an inputted quantum circuit remains, and wherein the selection component retains, after the selected qubits are removed, determined isomorphic subgraphs.

8. The system of claim 1, wherein the selection component determines admissible quantum computing device fragments, and wherein admissible fragments comprise fragments such that a coupling map is sizeable to embed a target circuit.

9. The system of claim 8, wherein the system further comprises a mapping component that determines and obtains feasible embedding layouts of the fragments on a circuit graph.

10. The system of claim 9, wherein the mapping component transpiles a quantum circuit backend to determine an optimal mapping under noise-independent conditions.

11. The system of claim 2, wherein the scoring component scores determined fragment embedding layouts on a circuit graph, and wherein the selection component selects, based on the scored fragment embeddings, a minimum score fragment embedding layout as an optimal virtual-to-physical qubit mapping.

12. The system of claim 1, wherein the selection component performs, based on accuracy and optimization requirements, a second sparse learning on fragment embedding layouts and selects a quantity of optimal virtual-to-physical qubit mappings.

13. A computer-implemented method, comprising:
employing, by the system, sparse tomography to learn noise of a quantum computing device to build a sparse noise model of the quantum computing device; and
selecting, by the system, based on the sparse noise model and a quantum circuit, nodes and edges of a graph topology of the quantum computing device by removing selected qubits.

14. The computer-implemented method of claim 13, further comprising engaging a scoring component that scores, based on the sparse noise model, each node and edge of the graph topology.

15. The computer-implemented method of claim 13, further comprising removing selected qubits as long as at least one subgraph isomorphic to an inputted quantum circuit remains, and wherein the selection component retains, after the selected qubits are removed, determined isomorphic subgraphs.

16. The computer-implemented method of claim 13, further comprising determining admissible quantum computing device fragments, and wherein admissible fragments comprise fragments such that a coupling map is sizeable to embed a target circuit.

17. The computer-implemented method of claim 13, further comprising engaging a mapping component that determines and obtains feasible embedding layouts of fragments on a circuit graph.

18. The computer-implemented method of claim 17, further comprising scoring determined fragment embedding layouts on the circuit graph, and wherein the selection component selects, based on the scored fragment embeddings, a minimum score fragment embedding layout as an optimal virtual-to-physical qubit mapping.

19. A computer program product comprising a non-transitory computer-readable memory having program instructions embodied therewith, the program instructions executable by a processor to cause the processor to:
engage a learning component that employs sparse tomography to learn noise of a quantum computing device to build a sparse noise model of the quantum computing device; and
engage a selection component that selects, based on the sparse noise model and a quantum circuit, nodes and edges of a graph topology of the quantum computing device by removing selected qubits.

20. The computer program product of claim 19, wherein the program instructions are further executable to cause the processor to:
engage a scoring component that scores determined fragment embedding layouts on a circuit graph, and wherein the selection component selects, based on the scored fragment embeddings, a minimum score fragment embedding layout as an optimal virtual-to-physical qubit mapping.
